(19) United States
(12) Patent Application Publication
(10) Pub. No.: US 2011/0027762 A1
(43) Pub. Date: Feb. 3, 2011

(54) Method and System for Effecting Language Communications

(76) Inventors: Gregory Keim, Broadway, VA (US); Michael Scott Fulkerson, Harrisonburg, VA (US); Matthew Edwards Schenck, Charlottesville, VA (US)

Correspondence Address: Kaplan Gilman & Pergament LLP, 1480 Route 9 North, Woodbridge, NJ, 07095, US

(21) Appl. No.: 12/533,085

(22) Filed: Jul. 31, 2009

(51) Int. Cl. G09B 19/06

(52) U.S. Cl. 434/157

(57) ABSTRACT

Interaction in a target language among students and native speakers of the language is effected by providing a learning community having a set of language activities in a plurality of languages, including the target language. The activities include communications with others. A student is permitted full access to activities in the target language, while a native speaker in the target language is given access to a subset of activities in a language of his choice in exchange for having carried on a communication with a student in the target language.

### BACKGROUND OF THE INVENTION

The present invention relates generally to language teaching systems and, more particularly, concerns a method and system for effecting communication between students and skilled individuals in a target language.

In learning a foreign language, much is to be gained by a student from communicating with a native speaker of the language. Not only does the student learn a natural style of communication, but he becomes immersed in the rhythm and flow of the language. This is particularly true when it comes to verbal communication. When the student travels to another country, immersion in the target language is achieved easily. However, when engaging in on-line language learning, for example, it is difficult to find a sufficient number of native speakers or to motivate them to communicate with the student attempting to learn the language of the native speaker.

Another problem with immersing students in a foreign language with the use of native speakers is that the native speakers' language level is far above that of the student. This makes it relatively difficult for the student to participate in a meaningful conversation with the native speaker. A methodology is needed to bring the native speaker “down” to the level of the language learner in the learner's target language. One methodology for doing this is disclosed in copending U.S. patent application Ser. No. 12/436,268, owned by the assignee of the present invention. It involves monitoring the native speaker's communication and suggesting changes when it contains words or phrases beyond the student's understanding.

Another issue is that simply providing unstructured conversation with a native speaker is less than optimal. Instead, for the language learner to learn, it is best to engage in a set of structured language and conversational exercises that are optimized for the language learning, and often customized for the particular learner. It is not easy to find native speakers to engage in such structured two way exchanges to assist language learners.

Therefore, there exists a need to find, attract and motivate native speakers to communicate with language students, and to do so in a manner that causes the native speaker to speak at the level of the learner.

### SUMMARY OF THE INVENTION

In accordance with one aspect of the present invention, interaction in a target language (i.e.; the language the student is learning, but which is native to the native speaker) is effected by providing a learning community having a set of language learning activities in a plurality of languages, including the target language. The activities include language learning games implemented via software. The activities are preferably divided into two different subsets.

A first subset of premium activities includes teaching or pedagogic (“tutorial”) activities that are structured and controlled. For example, the activities are selected to use words in the target language, chosen by the native speaker in conversing with the student, that are relatively predictable and within the scope of what the student is expected to know. Optionally, the activities may also be customized to the level of the language learner. These activities may largely consist of those offered in connection with a structured customized lesson plan for computerized or on-line language learning. Hence, a productive conversation for the student can occur.

The second subset of activities is generally unstructured, and allows for more fluent, free flowing conversation. This set of activities permits a language learner to practice a language in which he has some proficiency and speaks relatively fluently, but which is still somewhat foreign to him. So, these types of activities may be items such as “Discuss your vacation last summer . . . ” or similar vague types of unstructured language activities. Hence, the native speaker is permitted some unstructured language practice in a language in which he has some proficiency or is an advanced learner.

A student is permitted full, premium access, including the first subset of activities in his target language, while a native speaker in the target language is given free access to only the second subset of activities in a language of his choice, such as the student's native language. Thus, for example, an English speaking student, who pays for a language learning course in Japanese, may learn that language by engaging in structured, learning activities with a native Japanese speaker in Japanese. In exchange, the native Japanese speaker, who may not be interested in paying for a course in English, can nonetheless practice his English via access to a limited set of language activities that he can execute with the native English speaker or others. Alternately, he might be given access to participate in a limited set of language activities with one or more other people speaking Italian, German, or some other language of his choice.

In the ensuing description, the learning community will be described as a site on the Internet, the World Wide Web, which would be a preferred method of realizing it presently. However, those skilled in the art will appreciate that it could be achieved in numerous ways, including private networks, kiosks, and the like.

### BRIEF DESCRIPTION OF THE DRAWINGS

The foregoing brief description and further objects, features and advantages of the present invention will be understood more completely from the following detailed description of a presently preferred, but nonetheless illustrative, embodiments in accordance with the present invention, with reference being ahead to the accompanying drawings in which:

FIG. 1 is a functional block diagram illustrating an embodiment of a learning community 10 in accordance with the present invention; and

FIG. 2 is a flow chart illustrating a preferred process for handling access to a chat module in an online learning community in accordance with the present invention.

### DETAILED DESCRIPTION OF THE PREFERRED EMBODIMENTS

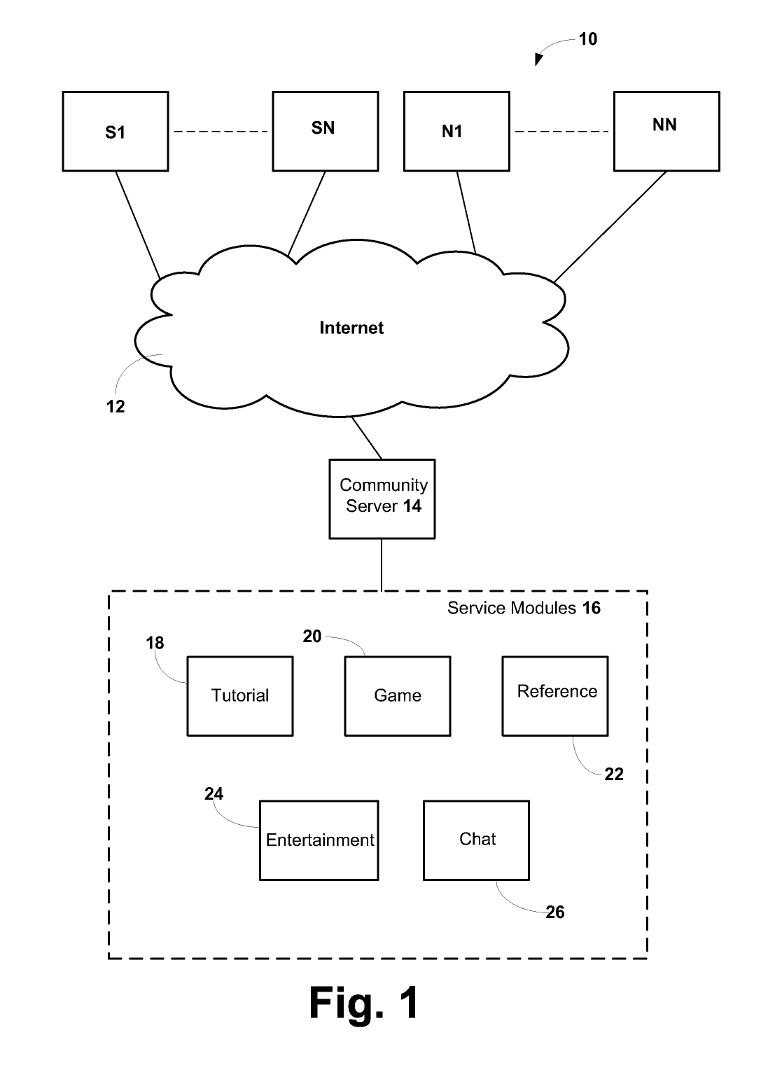

Turning now to the drawings, FIG. 1 is a functional block diagram illustrating a learning community 10 embodying the present invention. Via a network 12, preferably the Internet, learning community users or members, including a plurality of students S1 . . . SN and a plurality of native speakers N1 . . . NN in various languages, communicate by means of computing devices, with a learning community server 14. Typically, a student or native speaker would be communicating by means of a personal computer, but those skilled in the art will appreciate that many other types of computing devices could be used, including, but not limited to, a smart telephone, a personal digital assistant (PDA), a pocket computer, or a laptop computer. The communications may be by text, verbally, or any other method.

Server 14 provides access for members to a plurality of service modules 16. Although these modules are shown herein as co-located with server 14, those skilled in the art will appreciate that they may, themselves, be websites to which server 14 redirects members. Among the available service modules, there is a tutorial or pedagogical teaching module 18, which provides intensive online training in a plurality of languages. Module 18 may operate in conjunction with a language teaching program running on a student's computing device.

A game module 20 provides a variety of games and language activities offering verbal and written training in various languages; and a reference module 22 provides a collection of dictionaries, thesauruses, and similar references in various languages. Video and audio entertainment in various languages is offered by an entertainment module 24. A chat module 26 permits typed and verbal chats in various languages among members.

In a preferred embodiment, paying users, such as students, may enter a username and login, and are given access to all of the language activities in their target language. Those activities include a variety of interactive exercises and games that may be done with a native speaker in the target language. The activities are preferably structured, so that the usable vocabulary is limited to those words that the language learner can be expected to understand in the target language.

Preferably, the student will be presented with array of graphics and images related to an inquiry to immerse the student in the subject matter and enhance learning and retention of information. A method and apparatus for doing so is disclosed in copending U.S. patent application Ser. No. 12/412,472, owned by the assignee of the present patent application. Additionally, such activities may be customized to the paying language learner, and may use any of the techniques and teaching methodologies described in copending application Ser. Nos. 11/618,485, 11/846,188 or 12/052,435. Prior art techniques of language learning and customization may be employed as well.

As it is desirable to have activities that involve conversational interaction with native speakers, it is necessary to obtain native speakers with whom the language learners can interact. For example, if an English speaker trying to learn Japanese pays for the right to engage in the structured activities that involve interaction with a Japanese native speaker, there must be a manner in which to motivate Japanese speakers to spend time conducting structured activities with English speakers. While the obvious manner to do so might be to have the English speaker similarly engage the Japanese native speaker, the problem is that the Japanese speaker may not wish to pay to learn English if he already speaks basic English. Moreover, allowing the Japanese speaker to be similarly engaged in English without paying would require the structured language learning activities to be given away free to all users in various languages.

The solution to this embodied in the present invention is to realize that there are likely many Japanese users that, while not willing to pay to learn English using a structured language course, may nonetheless be willing to donate some time in structured communications or playing structured language games and activities with a learner of Japanese in exchange for some basic, unstructured conversation in English, for example with a native English speaker, or another language, to practice their language skill. Hence, the English part of the activities between the Japanese native speaker, and the paying Japanese language learner, may be simply a photograph to discuss, or some other non structure language exercises.

In such a situation, if the Japanese native speaker wishes to learn English “from scratch” the methodology will not work—he will have to pay for the language learning course. However, if he wishes to simply practice English to fine tune his skills, he can do so for free by engaging in language learning for a short time that will assist the English learner.

Thus, the premium activities are those that are structured to teach a target language to a student in a curriculum, for example, with the system controlling what words will constitute proper responses to the language activities based specifically upon what words the student knows, or potentially a customized or semi-customized curriculum for language learning. On the other hand, the “free” language activities are a set of unstructured, non-customized activities, such as “Discuss this photograph” or “Explain what you do at work”. These types of activities are not well suited for practicing specific words of a customized or semi-customized curriculum.

In addition, rather than the Japanese native speaker being given an opportunity to practice only in the English language with the English speaker, he can practice in any language with any speaker. In this regard, this application hereby incorporates by reference the entirety of copending and commonly owned U.S. application Ser. No. 12/143,148, entitled Economic Language Learning System. In the '148 application, a system of economics is disclosed where native speakers may exchange practice time with language learners in various languages, and wherein speaking time, time of day, language and other parameters are used to “value” learning time to practice sessions can be exchanged among users. In adding the teachings of the present invention, an additional parameter in the valuation can be whether the user is a paying or free user as described herein.

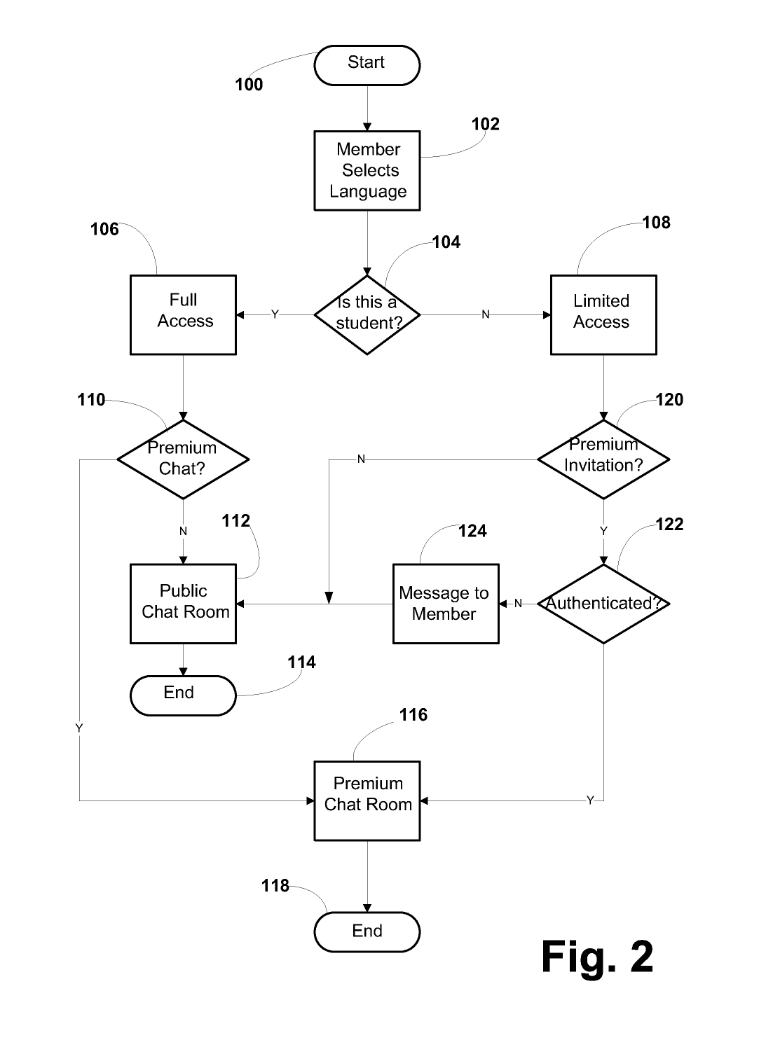

FIG. 2 is a flow chart illustrating an exemplary preferred process for handling access to the chat module 26 in the preferred embodiment 10 of a learning community in accordance with the present invention. The process starts at block 100, after a member requests access to the chat module 26, and, at block 102, the member requesting access selects the language for the chat.

Students purchase paying privileges in advance, and may purchase such paying privileges in one or more languages. Moreover, while only two levels are used herein—premium and non-paying—the same techniques can be applied to plural levels of student, with each level costing more and giving access to more capabilities, and better language practicing and learning techniques.

At block 104, a test is performed to determine whether the member requesting access is a student (a premium or paying member) in the selected language. It should be understood that a member may be a student in one or more languages and a native speaker in one or more other languages. For example, an individual who is a native speaker in the English language could be a student in the Spanish language. The nature of his access to the chat module therefore depends upon the language that he selected. If it is determined at block 104 that the member is a student for the present language, control is transferred to block 106, where the student is given full access to the chat module. On the other hand, if it is determined at block 104 that the member is not a student for the present language, control is transferred to block 108, where the member is given limited access to the chat module.

At block 110, accessed only by members with full access, a test is performed to determine whether the full-access member (student) has requested a premium chat. If not, the member is transferred to a public chat room at block 112, where he remains until he signs out, at which time the process ends at block 114.

While in the public chat room, a member may carry on typed or spoken communications with other members. A student receives a notification on the screen of his computing device of all native speakers who are available for chat, with an indication of those that are qualified to carry on premium chats. It is contemplated that native speakers would be qualified for premium chats, for example, by means of a test. In the preferred embodiment, the student may issue an invitation to a private chat which can be accepted by any qualified native speaker and they can make arrangements for a premium chat. However, it would also be possible to permit the student to invite particular native speakers whom he is familiar with. During the present chat, the student could click a prescribed area of his screen to authorize the chat, and be presented with a window in which he can authorize the chat and be presented with authentication information to be given to the native speaker. When the student authorizes the chat, a private message is sent to the native speaker with all the scheduling and authentication information. The student can terminate the public chat room session and reenters the chat module for a premium chat.

It should be appreciated that a student could also make arrangements for a premium chat, for example, by e-mail, after which he could authorize the chat.

If it is determined in the test at block 110 that the student has requested the start of a premium chat, control is transferred to block 116, where a premium chat room is opened for the student and a list of his authorized premium chats is displayed, from which he may select the intended session for the present premium chat. If his chat partner is not present, the student may simply wait for him to sign in.

On the other hand, the student may be presented with a list of members who are in the public chat room who are qualified to carry on premium chats, and he can momentarily carry on a private chat with one of them and invite him into the premium chat room. In doing so, he would click on the appropriate authorization area of the screen and enter the necessary information to authorize the premium chat. This information is sent privately to the selected native speaker.

When the student terminates the premium chat, the process ends at block 118. The accounting must also be updated, meaning the system then must reflect that the native speaker who engaged in the premium chat (but who is not a paying customer n the target language of that premium chat) t is now entitled to a certain amount of “credit” in another language of his choice.

In other embodiments, the public chat room is eliminated entirely, and the native speaker, at the time of the premium chat, immediately follows with a non-paying activity in the native language of the paying customer. In this embodiment, all chats are set up with two portions, a paying part of the structured language games, and corresponding non-paying part with the unstructured, non-premium services in the native language of the paying user.

Returning to FIG. 2, after a member is given limited access at block 108, control is transferred to block 120, when the member must indicate whether this is a response to an invitation to a premium chat. If he indicates that it is not, control transfers to block 112 with the members given access to the public chat room. On the other hand, if the member indicates that this is a response to an invitation to a premium chat, control transfers to block 122, where the member must provide authentication information for the premium chat.

If at block 122 authentication fails after a given number of attempts, control transfers to block 124, where a message is sent to the member informing him that authentication has failed, and control transfers to block 112 where the member is given access to the public chat room. If the authentication at block 122 is successful, control transfers to block 116 whether members is given access to the premium chat room for the authorized chat.

While in a premium chat, a native speaker earns participation credits, which he may “spend” to gain access to services not normally available to him. For example, a native speaker's access to games or entertainment may be severely limited. However, he may use participation credits to gain access to a subgroup of games our entertainment that would normally not be available to him. The number of credits a native speaker earns may be determined by such factors as the length of his premium chat and the availability of native speakers in his language. A native speaker in an uncommon language might receive substantially more credits per minute and a native speaker in a common language.

As a further example of how a native speaker might be rewarded, his chatting activities might normally be limited to his native language. However, in exchange for participation credits, he could be permitted to chat in another language of his choice. For example, a native Spanish speaker might be permitted to chat in a chat room in the English language in order to practice his English.

In still other embodiments, it is possible to earn enough credit by participating as a native speaker in premium chats with a language learner to even get enough credit for access to premium chat capabilities in a different language.

Although preferred embodiments of the invention have been disclosed for illustrative purposes, those skilled in the art will appreciate that many additions, modifications, and substitutions are possible without departing from the scope and spirit of the invention as defined by the accompanying claims.

What is claimed:

1. A method comprising:
providing plural sets of language learning or practice activities in a plurality of languages;
permitting a first student access to a first set of language learning or practice activities in a target language of said first user, said first set of language learning activities being conducted with a second user, and being selected from said plural sets; and
permitting the second student access to a second and different set of language activities in a different language in response to said second user participating in said first set of language learning or practice activities with said first student, said second set also being selected from said plural sets.

2. The method of claim 1 wherein the second student is a native speaker of the target language.

3. The method of claim 1 wherein the activities include verbal communications.

4. The method of claim 1 wherein the providing step comprises making the activities available via a network to a student or a skilled individual operating a computing device communicating with the network.

5. The method of claim 1 wherein the step of permitting a student comprises permitting a student to carry on a premium communication with a skilled individual in the target language of the first student.

6. The method of claim 5 wherein the communication is a verbal communication.

7. The method of claim 1 further comprising awarding the second student credits for participating in a premium communication with a student in the target language, which credits the second student may exchange for participation in an activity which would not be available to him otherwise.

8. The method of claim 7 wherein the activity which would not be normally available is communicating with others in a language other than the target language.

9. The method of claim 7 wherein the number of credits awarded a skilled individual is related to the duration of said communication with a student in the target language.

10. The method of claim 7 wherein the number of credits awarded a skilled individual is related to the particular target language.

11. The method of claim 1 wherein the first student must pay a fee to be permitted access.

12. The method of claim 1 wherein the second student pays no fee for access or pays a lesser fee than said first student.

13. The method of claim 1 wherein the first and second activities are related as set and subset.

14. A learning system effecting interaction in a target language among students and skilled individuals in the target language, including a network accessible processor providing access to:
a first executable program providing a set of activities in a plurality of languages, including communications with others;
a second executable program permitting a student full access to activities in the target language; and
a third executable program permitting a skilled individual access to a limited set of activities in a language of his choice as a reward for having carried on a communication with a student in the target language.

15. The system of claim 14 wherein the skilled individuals are native speakers of the target language.

16. The system of claim 14 wherein the communication is a verbal communication.

17. The system of claim 14 wherein the second executable program permits a student to carry on a premium communication with a skilled individual in the target language.

18. The system of claim 17 wherein the communication is a verbal communication.

19. The system of claim 14 wherein the third executable program awards the skilled individual credits for participating in a premium communication with a student in the target language, which credits the skilled individual may exchange for participation in an activity which would not be available to him otherwise.

20. The system of claim 19 wherein the activity which would not be normally available is communicating with others in a language other than the target language.

21. The system of claim 19 wherein the number of credits awarded a skilled individual by the third executable program is related to the duration of said communication with a student in the target language.

22. The system of claim 19 wherein the number of credits awarded a skilled individual by the third executable program is related to the particular target language.

23. The system of claim 14 wherein a student must pay a fee to be permitted access by the second executable program.

24. The system of claim 14 wherein a skilled individual is permitted access by the third executable program after paying a fee which is substantially less than any fee paid by a student or without paying a fee.

25. The system of claim 14 further comprising a fourth executable program monitoring communications to the student in the target language and ensuring that they would be expected to be understood by him.

26. A method comprising conducting bidirectional communication in a first language and a second language between first and second users, the communication comprising first activities in a first language and second activities in a second language, the method further comprising storing the first and second activities in each of a plurality of languages, and allowing the first and second users to engage in the communication by engaging in first activities in the target language of the first user, and second activities in the target language of the second user, and prohibiting the first activities in the target language of the second user.

27. The method of claim 26 wherein said step of prohibiting is based upon failure to enter a password.

28. The method of claim 27 wherein said step of prohibiting is implemented based upon whether a user has paid for a language learning course or not.

29. A method comprising storing language learning activities in two classes, premium class and non-premium class, and in plural languages;
Providing access to first and second users to said activities so that said first and second users can interactively engage one another in said premium activities in a first language, and in said non-premium activities in said second language.

30. The method of claim 29 whereby said first language is a target language of said first user, and said second language is a target language of said second user.

31. The method of claim 30 wherein the premium class activities are customized to the knowledge level of said first user, and are based upon past language learning activities in which said first user has engaged, and the non-premium activities are not so customized or based upon past language learning activities of said second user.
